(19) United States
(12) Patent Application Publication
(10) Pub. No.: US 2009/0248437 A1
(43) Pub. Date: Oct. 1, 2009

(54) SYSTEMS AND METHODS UTILIZING NFC TECHNOLOGY TO IMPLEMENT AN ON-DEMAND PORTABLE MEDICAL RECORD

(75) Inventors: Robert Gucciardi, South Burlington, VT (US); Scott Michael Cerreta, South Burlington, VT (US); Jeff Hutchinson, Winooski, VT (US); Jeff I. Chu, Buffalo Grove, IL (US); Ashish Vassa, Palatine, IL (US); Nikhil Jain, Barrington, IL (US); Priya Padate, Palatine, IL (US)

Correspondence Address: HANLEY, FLIGHT & ZIMMERMAN, LLC, 150 S. WACKER DRIVE, SUITE 2100, CHICAGO, IL, 60606, US

(73) Assignee: GENERAL ELECTRIC COMPANY, Schenectady, NY (US)

(21) Appl. No.: 12/056,881

(22) Filed: Mar. 27, 2008

(51) Int. Cl. G06Q 50/00

(52) U.S. Cl. 705/2

(57) ABSTRACT

In certain embodiments, an on-demand portable medical record system using near field communication includes a near field communication (NFC) storage device adapted to retrieve patient medical data for storage on the NFC storage device and a NFC retrieval device adapted to engage in near field communication with the NFC storage device to retrieve the patient medical data from the NFC storage device. An emergency on-demand portable medical record system using near field communication includes a NFC-enabled medical alert device storing a patient identifier, and a NFC retrieval device adapted to engage in near field communication with the NFC-enabled medical alert device to retrieve the patient identifier from the NFC storage device. The NFC-enabled medical alert device transfers the patient identifier to the NFC retrieval device via near field communication, and patient medical data is transferred to a medical facility upon verification of the patient identifier.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to portable patient medical records. More particularly, the present invention relates to methods and systems utilizing near field communication technology for the implementation of an on-demand portable medical record.

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, equipment and computerized information systems. Personnel in a healthcare facility must manage a plurality of patients, systems, and tasks to provide quality service to patients. Healthcare personnel may encounter many difficulties or obstacles in their workflow.

Healthcare practice has become centered around electronic data and records management. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow. For example, during an imaging scan of a patient, medical personnel may access patient information, such as a patient exam order, that are stored in a medical information system. Alternatively, medical personnel may enter new information, such as history, diagnostic, and/or treatment information, into a medical information system during an imaging scan.

Currently, relevant patient information for a patient's entire lifetime exists in a number of formats that include paper, folders and disparate information systems from a variety of vendors and a variety of healthcare providers. Current systems cannot aggregate this information effectively. Additionally, current systems cannot display this information at one time so that healthcare providers have the ability to interpret a patient's complete medical history when assessing and diagnosing illnesses. Providers are rarely able to see the full history of a patient. More commonly, providers have only the information that they have gathered or that they have received in response to questions asked of the patient in a clinical setting. Key decisions are made with the limited knowledge available to the provider at the point at which the provider is making a decision.

Today, when patients visit a hospital or other healthcare facility, they are often inundated with paperwork to complete before they can be seen by a healthcare professional. Completion of paperwork can be time consuming, frustrating for patients who have previously filled out similar paperwork at the facility, and problematic when a patient does not remember all of his or her medical history.

When a patient walks into a hospital, administration is required to collect patient demographic information and create a personal profile for the patient. Information related to the patient is then associated with the profile. Each department associated with the patient is supposed to fill out forms for any kind of diagnostic information it acquires from the patient. Technologists must fill out forms prior to any scans. Nurses must fill out forms after diagnostic evaluation. Additionally, referring physicians have to complete requisition forms prior to requesting a scan.

Patient care information is generally accessed through stationary workstations at nursing stations, radiography reading rooms, and other care providing locations. Physicians moving around a hospital cannot configure the information display to his/her preferences.

Use of pre-printed forms that require the users to hand fill is very costly and inefficient. Healthcare administrators must collect all the forms and keep them together in the patient's file. Manual data entry also leads to critical errors. Changes cannot be made quickly and efficiently. Protecting and securing the critical patient information is not easy, as anyone can have access to those files and look up personal information.

Further, the only means of input to a pre-printed form is through use of a pen or pencil. Physically challenged and/or elderly patients sometimes have a difficult time holding the pen or writing on a paper. Some people have poor vision that inhibits them to read the contents of the documents they are asked to sign (for example, their rights and hospital privacy practice regulations).

Additionally, if a medical emergency occurs (e.g. a car accident in which one of the individuals sustains life threatening injuries and is unconscious), quick action can be important to save lives and reduce permanent injury. If an Emergency Medical Technician (EMT) can not obtain any medical history from an injured individual, the lack of information can cause problems for the EMT trying to help the individual while bringing him or her to the hospital and potentially endanger the individual and/or delay treatment at the hospital.

### BRIEF SUMMARY OF THE INVENTION

Certain embodiments of the present invention provide methods and systems for on-demand portable medical records.

Certain embodiments provide an on-demand portable medical record system using near field communication. The system includes a near field communication (NFC) storage device adapted to retrieve patient medical data for storage on the NFC storage device. The system also includes a NFC retrieval device adapted to engage in near field communication with the NFC storage device to retrieve the patient medical data from the NFC storage device.

Certain embodiments provide a method for near field communication of patient medical data. The method includes retrieving patient medical data from a medical information service to a near field communication (NFC)-enabled storage device. The method also includes initiating a transfer of the patient medical data from the NFC-enabled storage device to a NFC retrieval device by positioning the NFC-enabled storage device in close proximity to the NFC retrieval device. The method further includes transferring the patient medical data from the NFC retrieval device to a medical facility data storage for use in patient examination.

Certain embodiments provide an emergency on-demand portable medical record system using near field communication. The system includes a near field communication (NFC)-enabled medical alert device storing a patient identifier. The system also includes a NFC retrieval device adapted to engage in near field communication with the NFC-enabled medical alert device to retrieve the patient identifier from the NFC storage device. The NFC-enabled medical alert device transfers the patient identifier to the NFC retrieval device via near field communication. Patient medical data is transferred to a medical facility upon verification of the patient identifier.

### BRIEF DESCRIPTION OF SEVERAL VIEWS OF THE DRAWINGS

FIG. 1 illustrates an exemplary on-demand portable medical record system and workflow in accordance with an embodiment of the present invention.

FIG. 2 illustrates an exemplary un-attended on-demand portable medical record system and workflow in accordance with an embodiment of the present invention.

FIG. 3 illustrates an exemplary emergency on-demand portable medical record system and workflow in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments enable users to transfer the desired medical history and/or Personal Medical Information (PMI) from their cell phones to a retrieval device at a clinical site. Cell phone transfer of personal medical information can save time, improve user experience, and improve accuracy of information, for example.

In an emergency scenario, certain embodiments may be used to retrieve all or part of a patient medical history from the individual's cell phone and transfer the information into a mobile scanning device to provide an EMT, clinician, and/or other hospital staff/system with the information. In certain embodiments, security measures, such as password and/or biometric authentication, can be built into the phone and/or retrieval device to help ensure that the individual's information was not transmitted inappropriately.

Certain embodiments utilize Near-Field Communication (NFC) technology to convey an owner's medical history to a receiving NFC device that may be standalone or connected to a hospital's or healthcare provider's network, for example. If the device is connected to an authorized information network, the information is then passed from the NFC device to the site's medical record store and/or an associated display device (e.g. a GE Healthcares Centricity product storage and/or display). In certain embodiments, the clinical site can secure and store the patient's medical information.

NFC technology involves two NFC-enabled devices brought together in close proximity to transfer information. Positioning the devices in close proximity provides an added benefit of increased security and is an improvement over other radio wave technology, for example.

As will be described further below, a patient's medical information can be stored on a cellular phone and/or other similar portable device after being retrieved using one of several transfer options available.

Near Field Communication (NFC) is a short-range wireless connectivity technology. NFC can be used with a variety of devices, including mobile phones and/or other portable electronic devices transferring information. NFC operates using magnetic field induction at a frequency of, for example, 13.56 MHz and transferring data at up to 424 Kbits/second. NFC provides both read and write exchange of data between electronic devices. Communication can be initiated by bringing two NFC-enabled devices in close proximity.

In certain embodiments, communication between two NFC-compatible devices occurs when the devices are positioned, for example, within four centimeters of one another. As an example, a motion or touch by a user with a device can establish an NFC connection. The connection can be compatible with other known wireless technologies, such as Bluetooth or Wi-Fi. NFC communication technology operates according to accepted standards, such as International Standards Organization (ISO) and/or other telecommunications standards, for example. Due to the short transmission range, NFC-enabled transactions provide increased security.

In certain embodiments, NFC devices work within a range of 0-20 centimeters, for example. NFC devices can operate in one of two modes, for example. In a passive communication mode, an initiating device provides a carrier field, and a target device answers by modulating the existing field provided by the initiating device. In passive mode, the target device may draw its operating power from the electromagnetic field provided by the initiating device, thus making the target device a transponder.

In an active communication mode, both the initiating device and the target device communicate by generating their own fields. In active mode, both devices typically have a power supply.

A common data format has been defined for NFC communication. The common data format, called NDEF, can be used to store and transport different types of data, including MIME-type objects, short RTD-documents, such as URLs, and the like. Using NDEF, binary records are used which can hold different types of objects. In certain embodiments, for a data message, a type of the first record defines a context of the entire message.

The proximity-based communication of NFC devices gives a user more control over when communication happens. NFC communication also avoids a need to switch communication on or off, in contrast, for example, to Bluetooth. NFC communication is compatible with contactless card infrastructure and, because it cannot be read by machines covertly at a distance, provides increased security.

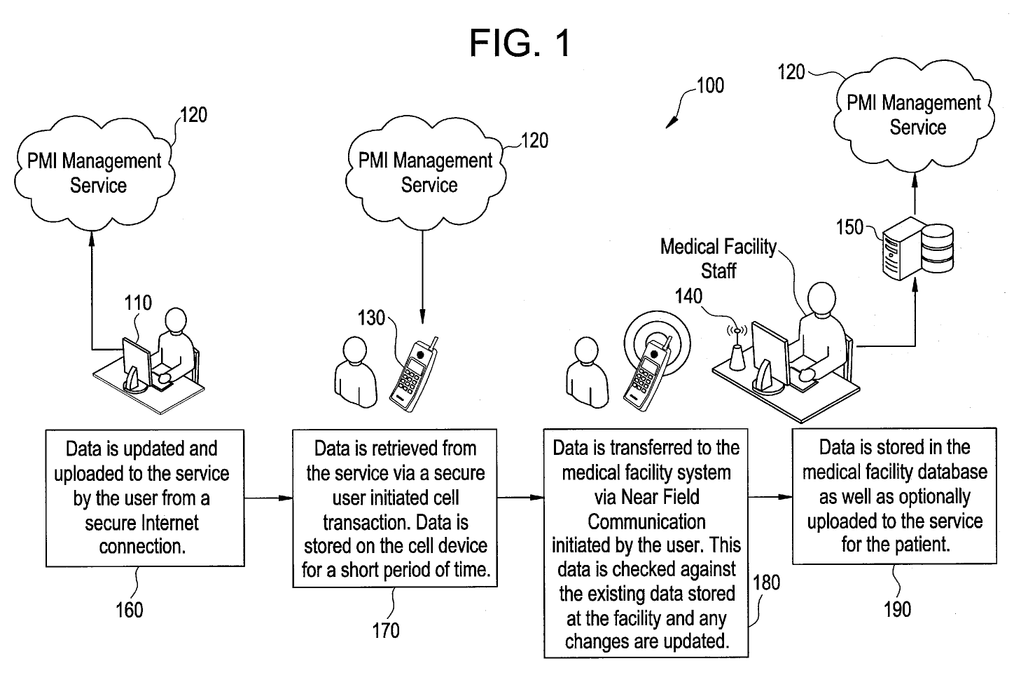

FIG. 1 illustrates an exemplary on-demand portable medical record system and workflow in accordance with an embodiment of the present invention. As shown in FIG. 1, the system 100 includes an input device 110, a personal medical information (PMI) management service 120, a portable NFC storage device 130, an NFC retrieval device 140, and medical facility storage 150.

In certain embodiments, the input device 110 may be a computer and/or other data input device for input of patient information. The NFC storage device 130 may be a cellular phone, personal digital assistant, and/or other handheld communication device, for example. The NFC retrieval device 140 may be a mobile NFC scanning device and/or other antenna-based system capable of receiving NFC information from the NFC storage device 130, for example.

As illustrated, for example, in the workflow of FIG. 1, at step 160, data is updated and uploaded to the PMI management service 120 by a user from an input device 110. Upload of information may be facilitated by a secure Internet or other network connection, for example. For example, patient medical information is entered by a physician via a hospital terminal and uploaded to the PMI service 120 using a secure hospital Internet connection.

At step 170, data is retrieved from the service 120 via a secure user-initiated communication, such as a cellular transaction. Alternatively and/or in addition, communication may be automatically initiated based on a schedule and/or trigger, for example. Data may be stored on the NFC storage device 130, such as a cell phone, for a short period of time. Alternatively and/or in addition, data may be stored in the device 130 for a longer period of time, such as until storage space is used for other and/or updated data.

At step 180, data is transferred to a medical facility system 150 via NFC initiated by the user. Alternatively and/or in addition, data transfer may be initiated automatically via close proximity between the NFC storage device 130 and the NFC retrieval device 140. Transferred data is checked again existing data stored at the facility 150 and any changes are updated and/or replaced, for example. Medical facility staff may be on hand to assist with data transfer and to verify the transferred data, for example.

At step 190, data is stored in the medical facility database 150, as well as optionally loaded to the PMI management service 120 for the patient. The PMI management service 120 may help the patient update and manage his or her own medical information, for example.

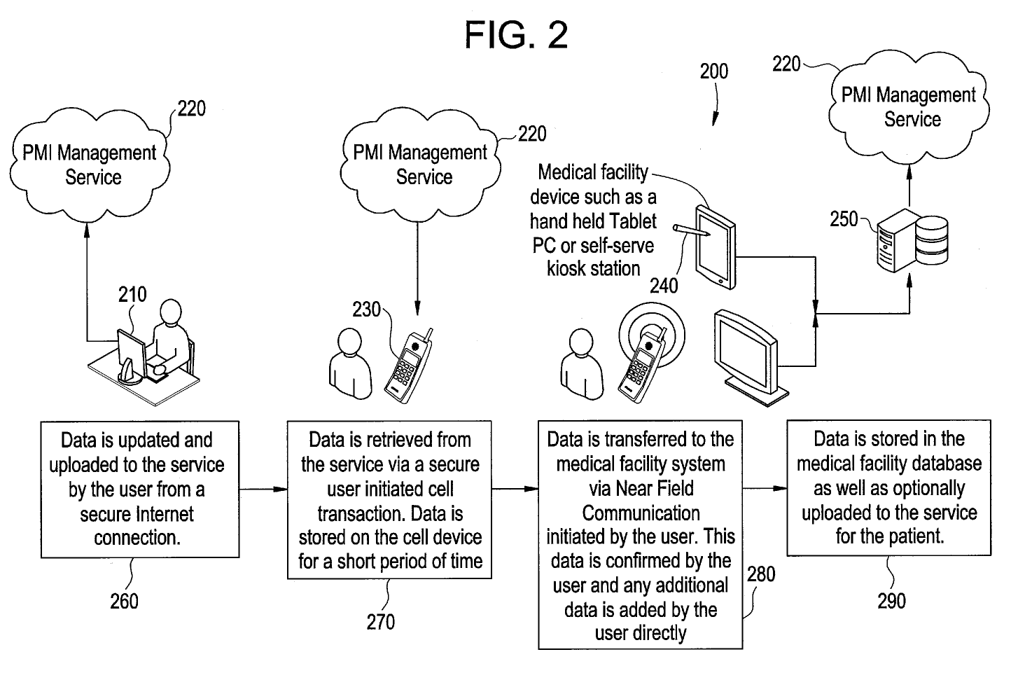

FIG. 2 illustrates an exemplary un-attended on-demand portable medical record system and workflow in accordance with an embodiment of the present invention. As shown in FIG. 2, the system 200 includes an input device 210, a PMI management service 220, a portable NFC storage device 230, an NFC retrieval device 240, and medical facility storage 250.

In certain embodiments, the input device 210 may be a computer and/or other data input device for input of patient information. The NFC storage device 230 may be a cellular phone, personal digital assistant, and/or other handheld communication device, for example. The NFC retrieval device 240 may be a mobile NFC scanning device and/or other antenna-based system capable of receiving NFC information from the NFC storage device 230, for example. The retrieval device 240 may be implemented in conjunction with and/or integrated with a computer for viewing and verification of data, for example.

As illustrated, for example, in the workflow of FIG. 2, at step 260, data is updated and uploaded to the PMI management service 220 by a user from an input device 210. Upload of information may be facilitated by a secure Internet or other network connection, for example. For example, patient medical information is entered by a physician via a hospital terminal and uploaded to the PMI service 220 using a secure hospital Internet connection.

At step 270, data is retrieved from the PMI service 220 via a secure user-initiated communication, such as a cellular transaction. Alternatively and/or in addition, communication may be automatically initiated based on a schedule and/or trigger, for example. Data may be stored on the NFC storage device 230, such as a cell phone, for a short period of time. Alternatively and/or in addition, data may be stored in the device 230 for a longer period of time, such as until storage space is used for other and/or updated data.

At step 280, data is transferred to a medical facility system 250 via NFC initiated by the user. Alternatively and/or in addition, data transfer may be initiated automatically via close proximity between the NFC storage device 230 and the NFC retrieval device 240. The data is reviewed and confirmed by the user using the NFC retrieval device 240, such as a hand-held tablet PC or self-serve kiosk station. Additional data may be added by the user directly via the device 240.

At step 290, data is stored in the medical facility database 250, as well as optionally loaded to the PMI management service 220 for the patient. The PMI management service 220 may help the patient update and manage his or her own medical information, for example.

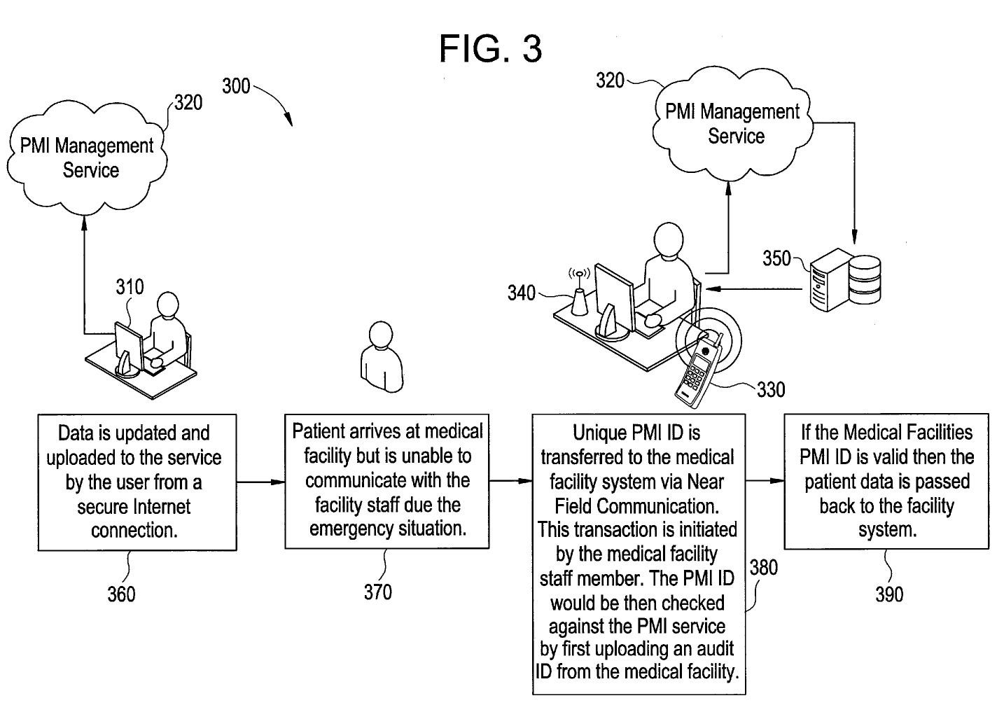

FIG. 3 illustrates an exemplary emergency on-demand portable medical record system and workflow in accordance with an embodiment of the present invention. As shown in FIG. 3, the system 300 includes an input device 310, a personal medical information (PMI) management service 320, a portable NFC storage device 330, an NFC retrieval device 340, and medical facility storage 350.

In certain embodiments, the input device 310 may be a computer and/or other data input device for input of patient information. The NFC storage device 330 may be a cellular phone, personal digital assistant, and/or other handheld communication device, for example. The NFC retrieval device 340 may be a mobile NFC scanning device and/or other antenna-based system capable of receiving NFC information from the NFC storage device 330, for example.

As illustrated, for example, in the workflow of FIG. 3, at step 360, data is updated and uploaded to the PMI management service 320 by a user from an input device 310. Upload of information may be facilitated by a secure Internet or other network connection, for example. For example, patient medical information is entered by a physician via a hospital terminal and uploaded to the PMI service 320 using a secure hospital Internet connection.

At step 370, a patient arrives at a medical facility but is unable to communicate with the facility staff due to an emergency situation. For example, an unconscious patient is brought to a hospital by ambulance.

At step 380, a unique PMI identifier is transferred to the medical facility system 350 via NFC communication. The transfer is initiated by medical facility staff between the NFC storage device 330 and the NFC retrieval device 340. The emergency NFC storage device 330 may be a cell-based device and/or other device, such as a medical alert device or wallet-sized identification card or other portable device capable of storing and transmitting an identifier. The PMI identifier is then check against the PMI service 120 by first uploading an audit identifier from the medical facility.

At step 390, if the medical facility's PMI identifier is valid, then the patient data is passed back to the facility system 350. In certain embodiments, data may be uploaded to the PMI management service 320 as well.

Thus, the NFC retrieval device 140, 240, 340 can communicate with the NFC storage device 130, 230, 330 via near field communication to retrieve patient information stored on the patient NFC storage device 130, 230, 330. The NFC retrieval device 140, 240, 340 may also communicate with the storage device 130, 230, 330 to store patient information. In certain embodiments, some or all of the personal information stored on the NFC device 130, 230, 330 may be read without authorization. In certain embodiments, no personal information stored on the NFC device 130, 230, 330 may be read without authorization. The authorization may be made by, for example, the patient or a medical administrator. Examples of personal information that may be accessed without authorization may include: patient name, address, patient contact information, and a patient identifier.

Patient information may include, for example, one or more of the following pieces of information: patient name, patient address, patient contact information, emergency contact information, insurance information, billing information, primary care doctor information, specialist information, drug information, allergy information, current medication information, and a patient identifier. Patient information may also include patient records and reports. In addition, patient information may also include, for example, biographical information, medical history, family history, genetic test results, blood test results, heart rate, blood pressure, blood flow, and biomarker presence information. The patient identifier may be unique, for example, within a network or globally. Blood test results may include, for example, test results for blood oxygen level, white blood cell count, T-cell count, complete blood count, thyroid, cardiac risk factors, cholesterol, proteins, PSA (prostate), waste products, and glucose. In certain embodiments, patient information may come from multiple sources. For example, patient information may come from one or more of the patient, an insurance company, an in-network healthcare provider, and an out-of-network healthcare provider.

The NFC retrieval device 140, 240, 340 may communicate with the medical facility and/or other network database or data storage 150, 250, 350 to retrieve patient information stored in the database 150, 250, 350. The NFC retrieval device 140, 240, 340 may also communicate with the facility storage 150, 250, 350 to store patient information in the storage 150, 250, 350.

In certain embodiments, patient data may be used to complete a medical report. The medical report may include patient information relating to, for example, a medical appointment or procedure, such as: a routine appointment, diagnostic scan, screening scan, lab work, or surgery.

In certain embodiments, a computerized mobile device, such as an NFC device described above and/or another hand-held device with processing and communications capability, is used to exchange patient information. The computerized mobile device communicates with back-end services, such as a PMI service, to display patient care information (e.g., patient demographics, test reports, radiology reports, diagnostic images, medications, lab reports, etc.) for patients near the device. In certain embodiments, the mobile device interacts with a back-end patient locator service, which tracks physical locations through technologies such as NFC, wireless RFID, or GPS and identifies patients that are within a configured range of the device. The device may dynamically retrieve patient care information from back-end storage devices for patients entering its range and reclaim local storage from patients having dropped off its range.

For inpatient care, as a care provider holding the device moves around a hospital, the mobile device can pre-load care information for patients being approached and may have care information for the patient being visited by the care provider.

For outpatient care, if the range of the device is configured to be a physician's waiting area, the device can pre-load patient care information for waiting patients. For identifiable patients entering an emergency room, the device may save data access time.

The mobile device interacts with other back-end services for accessing patient care information stored in back-end health care information systems, such as PACS, RIS/HIS, patient registration (e.g., Admit-Discharge-Transfer (ADT)), etc. The mobile device allows the user to enter notes or messages for patients and provides an avenue to disseminate such notes or messages to other users and/or store the content in back-end storage.

In certain embodiments, the mobile device uses a configurable pre-fetching algorithm to select which patient care information to include for retrieving and displaying. Different sets of information may be displayed for patients receiving different types of treatment.

In certain embodiments, the mobile device uses a configurable retention algorithm to select out-of-range patients to purge their data from local storage. Grace periods can be configured to eliminate repeated loading and purging of patients on an edge of the range.

In certain embodiments, the mobile device includes a hand-held tablet device that can display patient care information, accept simple text or voice input, and include wireless communication capability, such as NFC, RFID, or GPS communication. In certain embodiments, a tracking system, such as an NFC, RFID, or GPS location tracking system, tracks physical locations of patients and the mobile device.

A back-end service determines, based on physical locations in real time, which patients are in a configured fetching range of the mobile device (e.g., all patients within a given distance of the device or all patients in the same room of the device). Additionally, a back-end configuration service provides a convenient user interface for users to specify rules regarding: which types of patient care information should be loaded to the mobile device for patients within the fetching range. Rules may include patient conditions and treatment types as factors to choose relevant information. Another back-end service can access relevant patient care information for a patient from multiple hospital information systems, such as PACS, RIS/HIS, Pharmacy, Labs, etc. The service uses configuration information from the user interface service, for example, to determine what information is relevant care information. Further, a back-end configuration service provides a convenient user interface for users to specify rules regarding when to purge information belonging to patients out of range of the device.

A control module in the mobile device uses one or more back-end services. For example, the control module uses a back-end service to decide which patients are in its fetching range. For each in-range patient that does not have care information in the device, the control module requests a back-end service to load such information. In certain embodiments, priority of loading is given to the closest patient. The control module uses configuration information from a back-end service to identify patients whose information can be purged from the device to free up data storage. If a physician enters additional information for a patient, the control module uses a back-end service to update relevant back-end systems and/or send e-mail, phone, or page messages, for example.

By dynamically discovering patients in range and pre-loading their information, certain embodiments overcome two main limitations of lightweight mobile devices: local storage size and network bandwidth. Information can be delivered in a just-in-time fashion. With important information conveniently available to healthcare providers, hospital can improve efficiency of delivering care.

Thus, certain embodiments provide a technical effect of integrating NFC and/or other wireless devices with healthcare information systems and patient electronic medical records. An on-demand patient medical record of ODPMR replaces a manual process for providing medical history to providers. For example, NFC technologies can be leveraged to interact with a central storage service, a patient hand held device and provider devices.

Among other things and as illustrated above, using NFC technology for transmitting a patient's medical history to a provider's system provides time savings, helps improve patient experience, helps improve accuracy and completeness of patient record information, and helps provide access to medical history information, often in critical situations. Using NFC technology, a patient will not have to fill out forms, and the medical information will not have to be re-keyed into a provider's information system, for example. Using NFC technology helps reduce an amount of frustrating paperwork patients have to fill out before being seen in a clinical environment. Additionally, while patients often do not remember all of their medical history and it is possible for patients to enter the wrong information or for information to be misread by providers, automated NFC exchange of patient medical information helps provide a more complete and accurate record. Additionally, if patients are unconscious, their NFC enabled cell phones could provide the information for them.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of a variety of healthcare information systems. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. An on-demand portable medical record system using near field communication, the system comprising:
a near field communication (NFC) storage device adapted to retrieve patient medical data for storage on the NFC storage device; and
a NFC retrieval device adapted to engage in near field communication with the NFC storage device to retrieve the patient medical data from the NFC storage device.

2. The system of claim 1, further comprising a personal medical information management service aggregating and storing medical data in association with a patient.

3. The system of claim 1, further comprising an input device facilitating patient input and upload of medical data to the patient medical information management service.

4. The system of claim 1, further comprising a medical facility storage storing patient medical data from the NFC storage device as received by the NFC retrieval device for use by medical facility personnel.

5. The system of claim 1, wherein the NFC storage device comprises a cellular phone.

6. The system of claim 1, wherein the NFC storage device comprises an NFC-enabled identification card.

7. The system of claim 1, wherein the NFC retrieval device comprises an NFC-enabled kiosk.

8. The system of claim 1, wherein the NFC retrieval device uses a configurable retention algorithm to dynamic retrieves patient medical data for patients within a range and release from local storage patient medical data for patients leaving the range.

9. The system of claim 1, wherein the NFC storage device uses a configurable retention algorithm to dynamically retrieve patient medical data for patients within a range and release from local storage patient medical data for patients leaving the range.

10. The system of claim 1, further comprising a user interface allowing a user to specify rules regarding types of patient information to be loaded to at least one of the NFC storage device and the NFC retrieval device.

11. A method for near field communication of patient medical data, the method comprising:
retrieving patient medical data from a medical information service to a near field communication (NFC)-enabled storage device;
initiating a transfer of the patient medical data from the NFC-enabled storage device to a NFC retrieval device by positioning the NFC-enabled storage device in close proximity to the NFC retrieval device; and
transferring the patient medical data from the NFC retrieval device to a medical facility data storage for use in patient examination.

12. The method of claim 11, further comprising confirming the patient medical data at the NFC retrieval device prior to the transferring step.

13. The method of claim 12, wherein the patient medical data is confirmed by the patient.

14. The method of claim 12, wherein the confirming step further comprises verifying the patient medical data against existing data stored at the medical facility data storage.

15. The method of claim 11, further comprising inputting and uploading patient medical data from an input device to the medical information service.

16. The method of claim 11, wherein the NFC-enabled storage device comprises a cellular phone.

17. The method of claim 11, wherein the NFC-enabled storage device comprises an NFC-enabled identification card.

18. The method of claim 11, wherein the NFC retrieval device comprises an NFC-enabled kiosk.

19. The method of claim 11, wherein said initiating step further comprises initiating a transfer of the patient medical data from the NFC-enabled storage device to a NFC retrieval device in response to emergency personal by positioning the NFC-enabled storage device in close proximity to the NFC retrieval device, wherein the NFC-enabled storage device comprises a medical alert device.

20. An emergency on-demand portable medical record system using near field communication, the system comprising:
a near field communication (NFC)-enabled medical alert device storing a patient identifier; and
a NFC retrieval device adapted to engage in near field communication with the NFC-enabled medical alert device to retrieve the patient identifier from the NFC-enabled medical alert device,
wherein the NFC-enabled medical alert device transfers the patient identifier to the NFC retrieval device via near field communication and wherein patient medical data is transferred to a medical facility upon verification of the patient identifier.

21. The system of claim 20, wherein the patient medical data is transferred to the medical facility from a patient medical information service upon verification of the patient identifier.

22. The system of claim 21, wherein the patient identifier correlates with a patient medical record stored with the patient medical information service.

23. The system of claim 20, wherein the NFC-enabled medical alert device comprises at least one of a cellular phone and an identification card.

24. The system of claim 20, wherein the NFC retrieval device uses a configurable retention algorithm to dynamic retrieves patient medical data for patients within a range and release from local storage patient medical data for patients leaving the range.

25. The system of claim 20, wherein the NFC-enabled medical alert device uses a configurable retention algorithm to dynamically retrieve patient medical data for patients within a range and release from local storage patient medical data for patients leaving the range.

26. The system of claim 20, further comprising a user interface allowing a user to specify rules regarding types of patient information to be loaded to at least one of the NFC-enabled medical alert device and the NFC retrieval device.
